(19) United States
(12) Patent Application Publication
(10) Pub. No.: US 2016/0331202 A1
(43) Pub. Date: Nov. 17, 2016

(54) WATER DISPENSER UNIT

(71) Applicant: KABUSHIKIKAISHA COSMO LIFE, Hyogo (JP)

(72) Inventor: Shingo ARAKAWA, Hyogo (JP)

(21) Appl. No.: 15/112,776

(22) PCT Filed: Feb. 24, 2014
(86) PCT No.: PCT/JP2014/054300

§ 371 Date: Jul. 20, 2016

(30) Foreign Application Priority Data
Jan. 31, 2014 (JP) 2014-016711

(51) Int. Cl. A47L 11/40; B67D 3/00

(52) U.S. Cl. CPC A47L 11/4091; A47L 11/4011; A47L 11/4013; A47L 11/4005; B67D 3/0009; B67D 3/0032; B67D 3/0038; B67D 3/0058; B67D 3/0022; A47L 2201/022; A47L 2201/04

(57) ABSTRACT

A water dispenser unit includes a water dispenser and a self-propelled cleaning robot, and the space for the water dispenser can be easily secured even in a limited living space. A robot receiving space is defined in the lower portion of the water dispenser such that the self-propelled cleaning robot can self-travel into and out of the robot receiving space. The water dispenser unit includes a charging station provided in the robot receiving space.

### TECHNICAL FIELD

The present invention relates to a water dispenser unit constituted by a water dispenser and a self-propelled cleaning robot.

### BACKGROUND ART

In the past, water dispensers were used mainly in offices and hospitals, etc. However, since interest in the safety of water or in health is growing these days, the number of water dispensers used in ordinary homes is increasing. Normally, water dispensers includes a cold water tank in which drinking water is stored, a cooling device for cooling the drinking water stored in the cold water tank, and a cold water spigot through which the drinking water stored in the cold water tank is discharged to outside, and by simply operating this cold water spigot, it is possible to use good drinking water at all times (e.g., the below-identified patent document 1).

As appliances capable of markedly reducing the burden of cleaning, self-propelled cleaning robots are gathering attention. Normally, self-propelled cleaning robots include a travel device for enabling the cleaning robots to travel on a floor surface, a dust collecting device for removing dust from the floor surface, and a built-in rechargeable battery for supplying electric power to the travel device and the dust collecting device so as to drive these devices. Such a self-propelled cleaning robot is very convenient, because it automatically cleans a floor surface even when a person is not at home or is in another room (e.g., the below-identified patent document 2).

### PRIOR ART DOCUMENT(S)

### Patent Document(s)

Patent document 1: Japanese Unexamined Patent Application Publication No. 2011-046446
Patent document 2: Japanese Unexamined Patent Application Publication No. 2009-238055

### SUMMARY OF THE INVENTION

### Problems to be Solved by the Invention

After finishing cleaning, such a self-propelled cleaning robot self-travels to return to a charging station placed on a floor, and is charged by/in the charging station. Namely, when not cleaning the floor, the self-propelled cleaning robot is not stored in a closet like a normal vacuum cleaner, but on standby in the charging station placed on the floor. Therefore, though it is necessary to secure, on the floor, a place for charging the self-propelled cleaning robot, if the self-propelled cleaning robot which is being charged exists on a floor in a limited living space, the cleaning robot might become an obstacle.

Though it is possible to markedly increase convenience by placing both a self-propelled cleaning robot and a water dispenser, if both of them are placed, it is necessary to secure both a place for charging the self-propelled cleaning robot and a place for placing the water dispenser, thus leading to the problem that an available space is made very small in the room.

The inventor focused on the point that while a self-propelled cleaning robot is charged by/in a charging station placed on a floor, a vertically elongated dead space exists above the self-propelled cleaning robot, and noticed that it might be possible to utilize a limited living space very effectively by utilizing this dead space so as to place a water dispenser.

It is an object of the present invention to provide a water dispenser unit which is constituted by a water dispenser and a self-propelled cleaning robot, and for which the space can be easily secured even in a limited living space.

### Means for Solving the Problems

In order to achieve the above object, the present invention provides a water dispenser unit comprising a water dispenser and a self-propelled cleaning robot, wherein the water dispenser comprises: a cold water tank in which drinking water is to be stored; a cooling device for cooling drinking water stored in the cold water tank; and a cold water spigot through which drinking water stored in the cold water tank is to be discharged to outside, wherein the self-propelled cleaning robot comprises: a travel device for enabling the self-propelled cleaning robot to travel on a surface floor; a dust collecting device for removing dust from the floor surface; and a rechargeable battery for supplying electric power to the travel device and the dust collecting device; wherein a robot receiving space is defined in the lower portion of the water dispenser such that the self-propelled cleaning robot can self-travel into and out of the robot receiving space, and wherein the water dispenser unit further comprises a charging station provided in the robot receiving space and capable of charging the rechargeable battery with the self-propelled cleaning robot received in the robot receiving space.

Since this water dispenser unit is configured such that when the self-propelled cleaning robot is received in the robot receiving space located at the lower portion of the water dispenser, the self-propelled cleaning robot is vertically aligned with the water dispenser, it is possible to save space, and thus to easily find a place for placing the water dispenser unit even in a limited living space.

It is preferable that the water dispenser further comprises a casing in which the cold water tank is provided, and a pedestal in which the robot receiving space is defined, wherein the pedestal is detachably attached to the bottom end of the casing.

With this arrangement, the pedestal of this water dispenser unit can be removed from the water dispenser to use the water dispenser alone. This means that the same components can be used both for the water dispenser used as a part of the water dispenser unit, and for the water dispenser used alone. It is therefore possible to reduce costs.

It is preferable that the pedestal and the casing are fastened to each other by a fastening means so as to be unmovable relative to each other. By fastening the pedestal and the casing together to each other by the fastening means, even if a person hits against the water dispenser or an earthquake occurs, the water dispenser will not topple down.

It is preferable that the water dispenser further comprises a first power cord through which electric power is to be supplied to the cooling device, wherein the pedestal includes a second power cord through which electric power is to be supplied to the charging station from a power outlet, and a power tap which branches off from the power supply line so as to supply electric power, and wherein the first power cord of the water dispenser is provided at the distal end of the first power cord with an insertion plug, and the insertion plug is connected to the power tap.

With this arrangement, this water dispenser unit makes it possible to supply electric power for activating the water dispenser and electric power for charging the self-propelled cleaning robot, not from a plurality of power outlets, but from a single power outlet. Therefore, it is possible to place the water dispenser unit even in a place where there are only a small number of power outlets.

### Effects of the Invention

The water dispenser unit of the present invention is constituted by the water dispenser and the self-propelled cleaning robot, and configured such that when the self-propelled cleaning robot is received in the robot receiving space located at the lower portion of the water dispenser, the self-propelled cleaning robot is vertically aligned with the water dispenser. Therefore, it is possible to save space, and thus to easily find a place for placing the water dispenser unit even in a limited living space.

### BRIEF DESCRIPTION OF THE DRAWINGS

FIG. 1 is a perspective view of a water dispenser unit according to an embodiment of the present invention when seen from above on the oblique front side of the water dispenser unit.

FIG. 2 is a sectional view of the water dispenser unit illustrated in FIG. 1.

FIG. 3 is an enlarged sectional view illustrating the vicinity of a pedestal of the water dispenser unit illustrated in FIG. 2.

FIG. 4 is a sectional view taken along line IV-IV of FIG. 3.

FIG. 5 is a sectional view of a pedestal different from the pedestal illustrated in FIG. 3.

FIG. 6 is a sectional view of a pedestal still different from the pedestal illustrated in FIG. 3.

FIG. 7 is a sectional view taken along line VII-VII of FIG. 6.

FIG. 8 is a front view of the pedestal illustrated in FIG. 6 when seen from the front side.

### BEST MODE FOR CARRYING OUT THE INVENTION

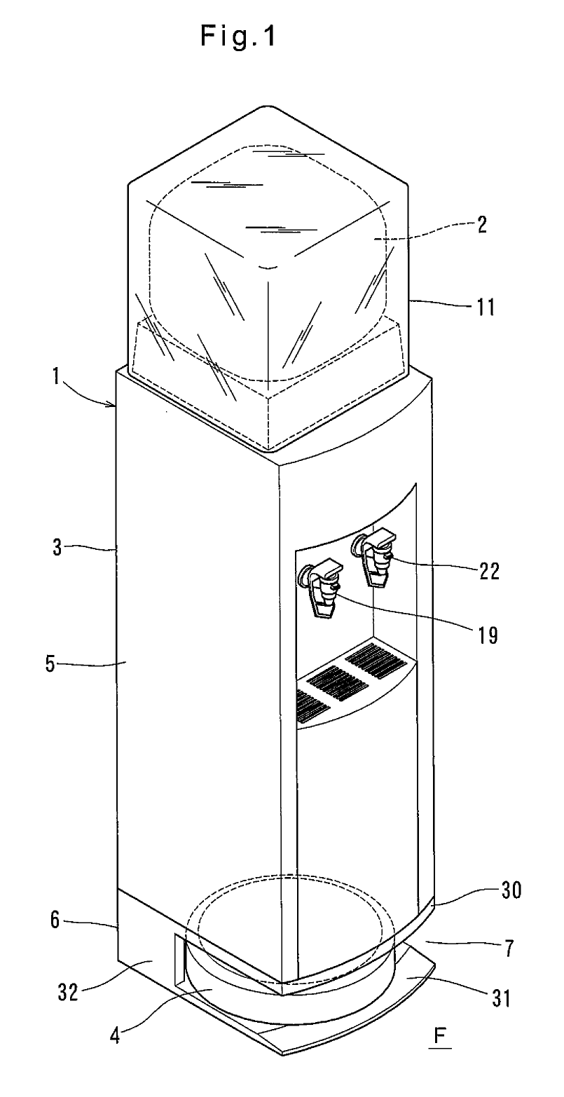

FIG. 1 illustrates a water dispenser unit 1 according to the embodiment of the present invention. This water dispenser unit 1 includes a water dispenser 3 in which drinking water is introduced from a replaceable raw water container 2, and supplied to outside, and a self-propelled cleaning robot 4 configured to automatically travel on a floor surface F so as to clean the floor surface F. The water dispenser 3 includes a vertically elongated tubular casing 5, and a pedestal 6 detachably attached to the bottom end of the casing 5. The pedestal 6 has a robot receiving space 7 defined therein such that the self-propelled cleaning robot 4 can self-travel (or travel by its own motive power) into and out of the robot receiving space 7.

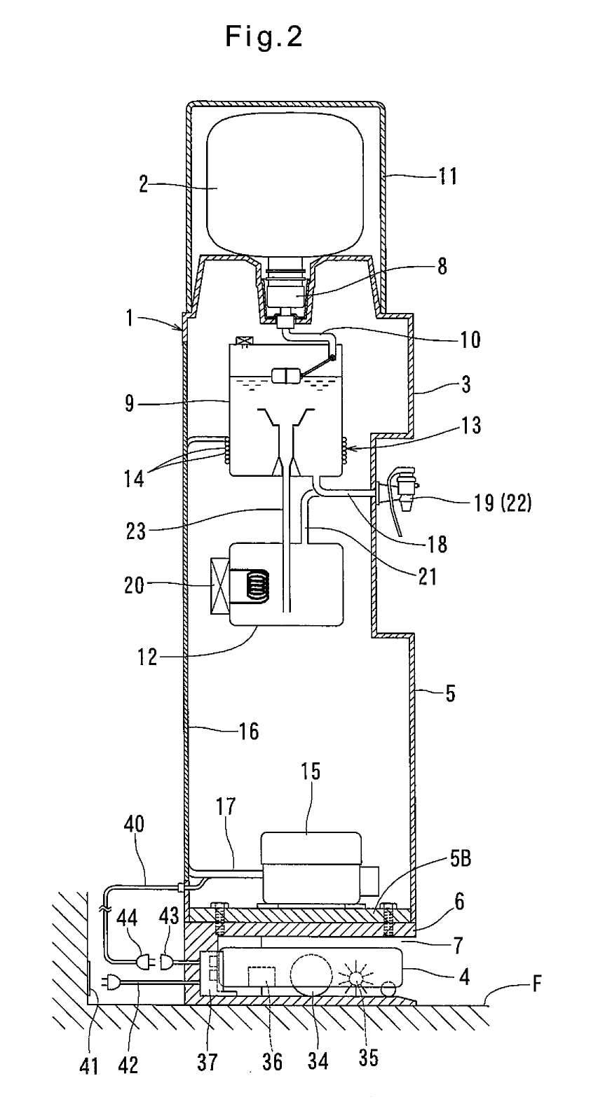

As illustrated in FIG. 2, the replaceable raw water container 2 is detachably placed on the top surface of the casing 5 with a water outlet 8 of the raw water container 2 directed downwardly. The maximum capacity of the raw water container 2, namely, the maximum amount of drinking water the raw water container 2 can hold, is about 8 to 20 liters. The water dispenser 3 includes a water introduction pipe 10 which is mounted to the top portion of the casing 5, and through which drinking water is introduced into a cold water tank 9 from the raw water container 2 placed on the top surface of the casing 5, and a decorative cover 11 attached to the top portion of the casing 5 so as to cover the raw water container 2.

The casing 5 houses therein the cold water tank 9, in which low-temperature drinking water is stored, and a hot water tank 12 in which high-temperature drinking water is stored. A cooling device 13 is attached to the cold water tank 9 to cool drinking water stored in the cold water tank 9. The cooling device 13 is constituted by a refrigerant pipe 14 wound around the outer periphery of the cold water tank 9, a compressor 15 fixed to the bottom portion 5B of the casing 5, and a condenser 16 arranged on the rear surface of the casing 5. The refrigerant pipe 14, the compressor 15 and the condenser 16 are connected together through a pipe 17. The refrigerant pipe 14 is cooled to about minus 15 to 30 degrees Celsius by activating the compressor 15, so that drinking water stored in the cold water tank 9 is kept at a low temperature (about 5 degrees Celsius).

A cold water discharge pipe 18 is connected to the bottom surface of the cold water tank 9 such that low-temperature drinking water stored in the cold water tank 9 is discharged through the cold water discharge pipe 18 to the outside of the casing 5. The cold water discharge pipe 18 has a cold water spigot 19 mounted thereto which is operable from the outside of the casing 5. By opening this cold water spigot 19, low-temperature drinking water can be discharged from the cold water tank 9 into a cup, etc. The capacity of the cold water tank 9 (its capacity to hold drinking water) is smaller than that of the raw water container 2, and is about 2 to 4 liters.

The hot water tank 12 is arranged under the cold water tank 9. A heating device 20 is attached to the hot water tank 12 to heat drinking water stored in the hot water tank 12. Though FIG. 2 illustrates a sheath heater as the heating device 20, the heating device 20 may be a band heater. The sheath heater is constituted by a pipe made of metal, and a heat-generating wire received in the pipe, and configured to generate heat when energized. The sheath heater is attached to the hot water tank 12 so as to extend through the wall of the hot water tank 12 into the hot water tank 12. The band heater is a cylindrical heat-generating member having a heat-generating wire embedded in the heat-generating member, and configured to generate heat when energized. The band heater is attached to the hot water tank 12 so as to come into close contact with the outer periphery of the hot water tank 12. The heating device 20 keeps drinking water stored in the hot water tank 12 at a high temperature (about 90 degrees Celsius).

A hot water discharge pipe 21 is connected to the top surface of the hot water tank 12 such that high-temperature drinking water stored in the hot water tank 12 is discharged to the outside of the casing 5 through the hot water discharge pipe 21. The hot water discharge pipe 21 has a hot water spigot 22 mounted thereto which is operable from the outside of the casing 5. By opening this hot water spigot 22, high-temperature drinking water can be discharged from the hot water tank 12 into a cup, etc. The capacity of the hot water tank 12 (its capacity to hold drinking water) is about 1 to 2 liters.

The interior of the cold water tank 9 communicates with the interior of the hot water tank 12 through a tank connection pipe 23 such that when drinking water is discharged from the hot water tank 12, drinking water equal in amount to the discharged drinking water flows through the tank connection pipe 23 into the hot water tank 12 from the cold water tank 9, so that the hot water tank 12 is always filled with drinking water.

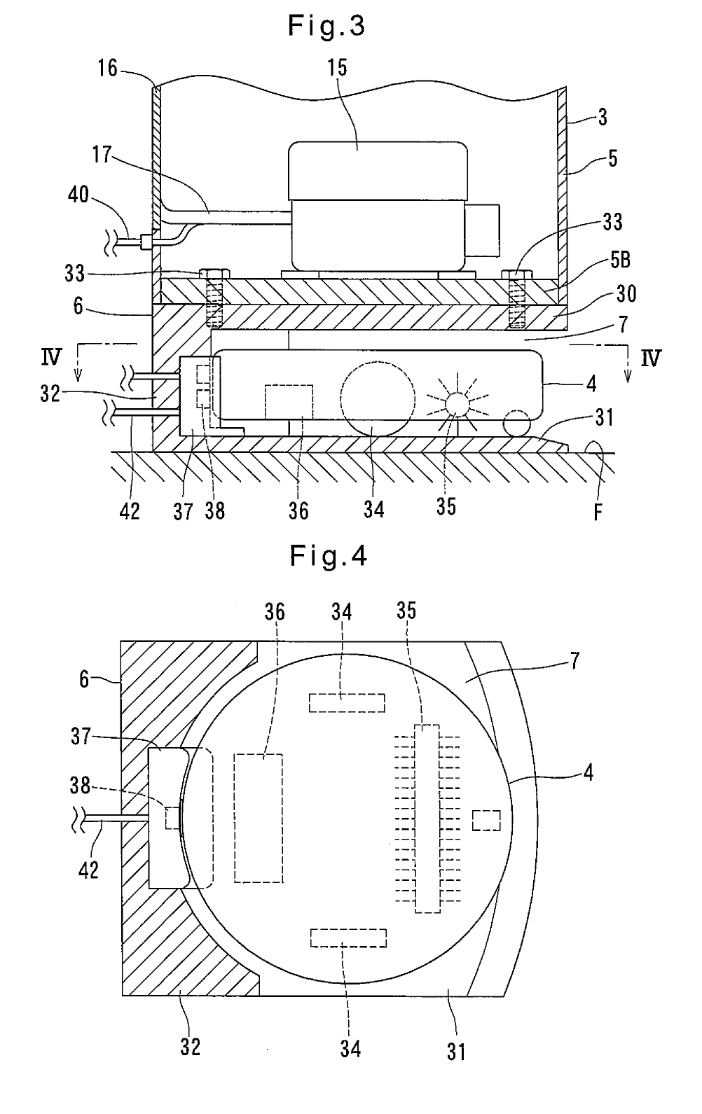

As illustrated in FIG. 3, the pedestal 6 includes a top panel 30 supporting the bottom portion 5B of the casing 5, a bottom panel 31 arranged under the top panel 30 so as to be opposed to the top panel 30, and a side panel 32 through which the rear portion of the top panel 30 and the rear portion of the bottom panel 31 are connected together. The top panel 30 of the pedestal 6 and the bottom portion 5B of the casing 5 are fastened to each other by a fastening means 33 such that the pedestal 6 and the casing 5 are unmovable relative to each other. As the fastening means 33, threaded fastening members (such as bolts and nuts) can be used. The robot receiving space 7 is defined between the top panel 30 and the bottom panel 31 such that the self-propelled cleaning robot 4 is received in the robot receiving space 7. As illustrated in FIG. 4, the top panel 30 and the bottom panel 31 are coupled together through the side panel 32 on the rear side of the pedestal 6 such that the robot receiving space 7 opens to the front side of the pedestal 6.

As illustrated in FIG. 3, the self-propelled cleaning robot 4 includes a travel device 34 for enabling the cleaning robot. 4 to travel on the floor surface F, a dust collecting device 35 for removing dust from the floor surface F, and a built-in rechargeable battery 36 for supplying electric power to the travel device 34 and the dust collecting device 35 so as to drive the devices 34 and 35. In this embodiment, as illustrated in FIG. 4, the self-propelled cleaning robot 4 is circular-shaped when seen from above, and has a diameter of 25 to 35 cm. Also, with the self-propelled cleaning robot 4 traveling on the floor surface F, the height of the cleaning robot 4 from the floor surface F to its top surface is set to be 5 to 10 cm.

The water dispenser unit 1 further includes a charging station 37 provided in the robot receiving space 7 and capable of charging the rechargeable battery 36 of the self-propelled cleaning robot 4 with the self-propelled cleaning robot 4 received in the robot receiving space 7. The charging station 37 is provided with charging terminals 38 located so as to come into contact with the self-propelled cleaning robot 4 when the cleaning robot 4 self-travels into the robot receiving space 7. The charging station 37 and the pedestal 6 are fastened to each other by a fastening means such as bolts (not shown) so as to be unmovable relative to each other.

The vertical width of the robot receiving space 7 is set to be larger by about 0.5 to 5.0 cm than the height of the self-propelled cleaning robot 4. By setting the vertical width of the space 7 to be larger by 0.5 cm or over than the height of the cleaning robot 4, it is possible to reliably prevent the cleaning robot 4 from interfering with the top panel 30. Also, by setting the vertical width of the space 7 not to be larger by more than 5.0 cm than the height of the cleaning robot 4, it is possible to make the pedestal 6 low in height, and thus to keep the water dispenser 3 stable. In order to reduce the area of the floor surface F occupied by the pedestal 6 when placed on the floor surface F, the size of the pedestal 6 is set such that the pedestal 6 is completely received within an imaginary square having four sides each of which is 50 cm (preferably 45 cm) in length when seen from above.

As illustrated in FIG. 2, the water dispenser 3 includes a power cord 40 through which electric power is supplied to the cooling device 13, the heating device 20, and a control circuit (not shown) for controlling the operation of the devices 13 and 20. The pedestal 6 is provided with a power cord 42 through which electric power is supplied to the charging station 37 from a power outlet 41. The charging station 37 is provided with a power tap 43 which branches off from the power cord 42 so as to supply electric power. The power cord 40 of the water dispenser 3 is provided at its distal end with an insertion plug 44, and this insertion plug 44 is connected to the power tap 43.

Since this water dispenser unit 1 is configured such that when the self-propelled cleaning robot 4 is received in the robot receiving space 7, which is located at the lower portion of the water dispenser 3, the cleaning robot 4 is vertically aligned with the water dispenser 3, it is possible to save space, and thus to easily find a place for placing the water dispenser unit 1 even in a limited living space.

The pedestal 6 of this water dispenser unit 1 can be removed from the water dispenser 3 to use the water dispenser 3 alone. This means that the same components can be used both for the water dispenser 3 used as a part of the water dispenser unit 1, and for the water dispenser 3 used alone. It is therefore possible to reduce costs.

This water dispenser unit 1 is very safe, because the pedestal 6 and the casing 5 are fastened to each other by the fastening means 33 so as to be unmovable relative to each other, so that even if a person hits against the water dispenser 3 or an earthquake occurs, the water dispenser 3 will not topple down.

This water dispenser unit 1 makes it possible to supply electric power for activating the water dispenser 3 and electric power for charging the self-propelled cleaning robot 4, not from a plurality of power outlets, but from a single power outlet such as the power outlet 41. Therefore, it is possible to place the water dispenser unit 1 even in a place where there are only a small number of power outlets.

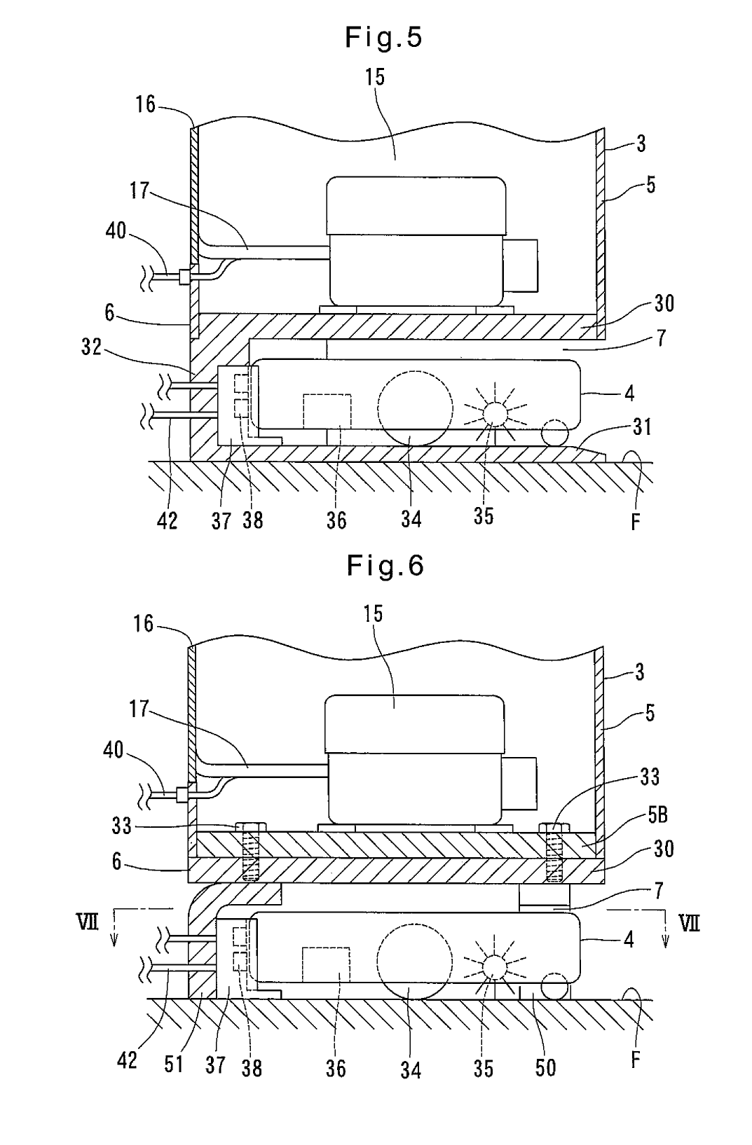

In the above embodiment, the pedestal 6, provided separately from the bottom portion 5B, is fixed to the bottom portion 5B, which closes the bottom opening of the casing 5. However, as illustrated in FIG. 5, the bottom portion 5B may be dispensed with such that the pedestal 6 per se closes the bottom opening of the casing 5 (namely, such that the pedestal 6 per se functions as the bottom portion 5B of the casing 5).

In the above embodiment, the water dispenser 3 of the water dispenser unit 1 is of the type in which drinking water is introduced into the cold water tank 9 from the replaceable raw water container 2. However, the water dispenser unit 1 may include a different type of water dispenser 3 in which drinking water is introduced into the cold water tank 9 from the public water supply system through a water purifying filter.

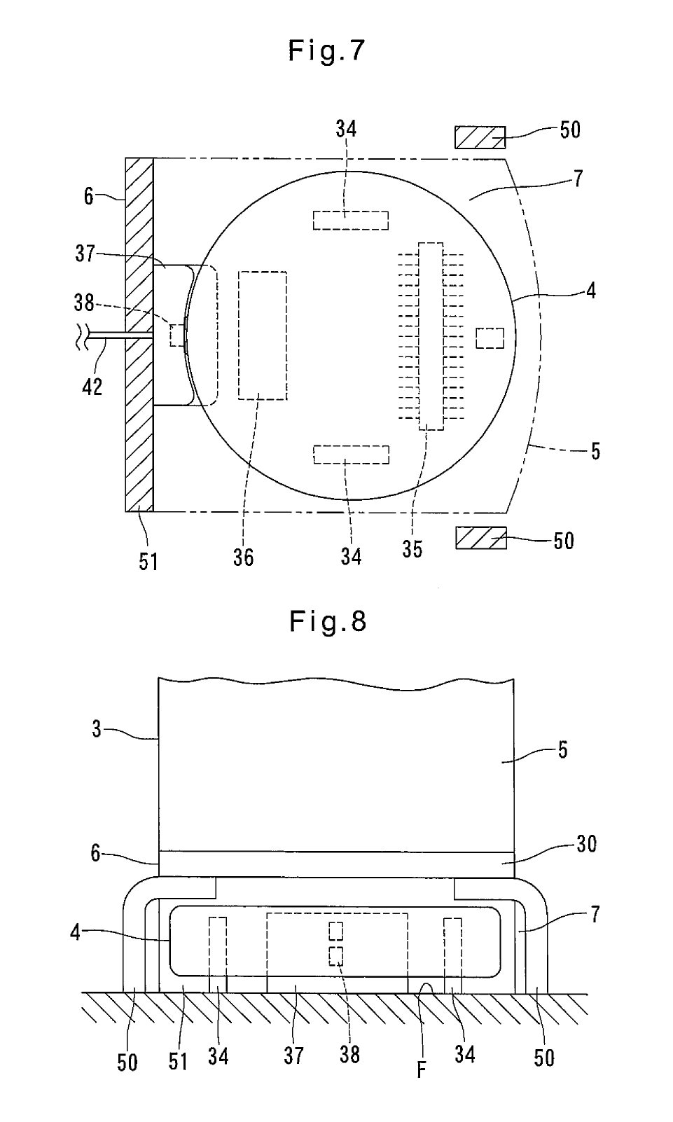

FIGS. 6 to 8 illustrate a different pedestal 6. As for the elements corresponding to those of the water dispenser unit 1 described in the above embodiment, the same reference numerals used in the above embodiment are used below, and their description is omitted. This pedestal 6 includes a top panel 30 supporting the bottom portion 5B of the casing 5, and a plurality of support legs extending downwardly from the outer peripheral portion of the top panel 30 and coming into contact with the floor surface F. The plurality of support legs are constituted by a pair of right and left support legs 50 located on the front side of the top panel 30, and a support leg 51 located on the rear side of the top panel 30. The support legs 50, located on the front side of the top panel 30, and the support leg 51, located on the rear side of the top panel 30, are spaced apart from each other in the front-to-rear direction of the top panel 30. The robot receiving space 7 is defined between the top panel 30 and the floor surface F such that the self-propelled cleaning robot 4 is received in the robot receiving space 7. The robot receiving space 7 opens to the front side of the pedestal 6 from between the pair of right and left support legs 50, so that from the front side of the pedestal 6, the self-propelled cleaning robot 4 can self-travel into and out of the robot receiving space 7.

If the pedestal 6 illustrated in FIGS. 6 to 8 is used, since the self-propelled cleaning robot 4 can go into and out of the robot receiving space 7 while traveling only on the floor surface F without having to travel from the floor surface F onto the bottom panel 31 illustrated in FIG. 3 and from the bottom panel 31 onto the floor surface F, the travel of the cleaning robot 4 into and out of the space 7 is smooth. Also, since gaps/spaces in the front-to-rear direction of the top panel 30 are defined between the respective support legs 50, located on the front side of the top panel 30, and the support leg 51, located on the rears side of the top panel 30, when infrared communication is performed between the self-propelled cleaning robot 4 and the charging station 37 so as to detect the relative position between the cleaning robot 4 and the charging station 37, it is possible to prevent irregular reflection of the infrared rays in the robot receiving space 7. As a result thereof, it is possible to stably perform such infrared communication, and thus to stabilize the motion of the self-propelled cleaning robot 4 when returning to the robot receiving space 7.

### DESCRIPTION OF REFERENCE NUMERALS

1: water dispenser unit
3: water dispenser
4: self-propelled cleaning robot
5: casing
6: pedestal
7: robot receiving space
9: cold water tank
13: cooling device
19: cold water spigot
33: fastening means
34: travel device
35: dust collecting device
36: rechargeable battery
37: charging station
40: power cord
41: power outlet
42: power cord
43: power tap
44: insertion plug
F: floor surface

1. A water dispenser unit comprising a water dispenser and a self-propelled cleaning robot,
wherein the water dispenser comprises:
a cold water tank in which drinking water is to be stored;
a cooling device for cooling drinking water stored in the cold water tank (9); and
a cold water spigot through which drinking water stored in the cold water tank is to be discharged to outside,
wherein the self-propelled cleaning robot comprises:
a travel device for enabling the self-propelled cleaning robot to travel on a floor surface;
a dust collecting device for removing dust from the floor surface; and
a rechargeable battery for supplying electric power to the travel device and the dust collecting device;
wherein a robot receiving space is defined in a lower portion of the water dispenser such that the self-propelled cleaning robot can self-travel into and out of the robot receiving space, and
wherein the water dispenser unit further comprises a charging station provided in the robot receiving space and capable of charging the rechargeable battery with the self-propelled cleaning robot received in the robot receiving space.

2. The water dispenser unit according to claim 1, wherein the water dispenser further comprises a casing in which the cold water tank is provided, and a pedestal in which the robot receiving space is defined,
wherein the pedestal is detachably attached to a bottom end of the casing.

3. The water dispenser unit according to claim 2, wherein the pedestal and the casing are fastened to each other by a fastening means so as to be unmovable relative to each other.

4. The water dispenser unit according to claim 2, wherein the water dispenser further comprises a power cord through which electric power is to be supplied to the cooling device,
wherein the pedestal includes a power supply line through which electric power is to be supplied to the charging station from a power outlet, and a power tap which branches off from the power supply line so as to supply electric power, and
wherein the power cord of the water dispenser is provided at a distal end of the power cord with an insertion plug, and the insertion plug is connected to the power tap.

5. The water dispenser unit according to claim 3, wherein the water dispenser further comprises a power cord through which electric power is to be supplied to the cooling device,
wherein the pedestal includes a power supply line through which electric power is to be supplied to the charging station from a power outlet, and a power tap which branches off from the power supply line so as to supply electric power, and
wherein the power cord of the water dispenser is provided at a distal end of the power cord with an insertion plug, and the insertion plug is connected to the power tap.
